(19) United States
(12) Patent Application Publication
(10) Pub. No.: US 2011/0277411 A1
(43) Pub. Date: Nov. 17, 2011

(54) DOOR ASSEMBLY SYSTEM

(76) Inventor: Kevin PERRON, Longueuil (CA)

(21) Appl. No.: 12/780,457

(22) Filed: May 14, 2010

(51) Int. Cl. E06B 3/72

(52) U.S. Cl. 52/458

(57) ABSTRACT

A versatile, yet sturdy, modular door assembly system comprising a plurality of modules forming the frame (stiles and rails) of the door, and means for non-permanently fixing the modules together. The assembly system may also comprise one or more interchangeable panels to be inserted between the modules, and cross or lock rails, mullions and/or muntins.

### FIELD OF THE INVENTION

The invention relates to a modular or knock-down door assembly system, comprising a plurality of modules forming a frame (stiles and rails) when assembled and one or more removable, and/or exchangeable panel. The invention relates to the modules forming the frame and to kits comprising them along with instructions for their assembly.

### BACKGROUND OF THE INVENTION

Doors come in all sizes and shapes. Most doors are generally one piece-doors, or permanently fixed multipart doors, for example, frame and panel construction type doors (e.g. five piece doors) having the stiles and rails forming the frame permanently glued together.

Doors form part of the decor in which they are inserted and can be used as decoration items as well. If one would change the environment surrounding the door, one would want to adapt the door to the new decoration style.

However, common doors do not allow for much variability. One piece doors may only be painted or changed completely. Panels of common multipart doors cannot be removed without damaging the door as the stiles and rails forming the frame holding the panels are permanently fixed together. The only solution available is to completely replace the doors to adapt to the new decor, which requires considerable expenses, especially if the redecorated room contains several doors, such as hallways, opened main floors, corridors, or doors of kitchen cabinets. As such, there is a need for a more versatile, but yet sturdy, door assembly system.

### SUMMARY OF THE INVENTION

One aspect of the invention provides a versatile, interchangeable, modular door assembly system in a “frame and panel” construction mode. The system comprises a plurality of modules, which when assembled, form a frame (stiles and rails of a door, or a frame for a mirror, picture, etc), each module comprising means for connecting each end in a male-female configuration in a perpendicular fashion.

The invention provides a door assembly system comprising a plurality of modules adapted for assembly to form a frame of a “frame and panel” type of door, each module comprising a first and second end, each of which comprising one or more complementary tongues and grooves for removably connecting each module to form the frame; and an interior and exterior edge, the interior edge having a groove along its longitudinal axis for slidably introducing one or more panels between the modules when assembled.

In one embodiment, the door assembly has a first and second modules, the first module comprising two stiles and a rail, and the second module comprising a second rail, or a first module comprising two rails and a stile, and the second module comprising a second stile.

In another embodiment, the door assembly system comprises a first, second, third and fourth modules. In this embodiment, the first and second modules are each adapted for perpendicular assembly to the third and fourth modules, with the first and second modules being parallel and facing each other, and the third and fourth modules being parallel and facing each other. The first and second modules may each comprise at each end a first and second tongues, and a groove, the first and second tongues being separated by the groove and pointing away from the modules along a longitudinal axis, preferably, the first tongue is the continuity of the exterior edge of the module, and the second tongue is the continuity of the interior edge of the module, and preferably the first and second tongues, taken together with the groove form an asymmetrical square U-shape. In a further embodiment, the first and second modules are respectively hinge and lock stiles, and third and fourth modules are respectively top and bottom rails of the door. In another embodiment, the first and second modules are respectively the top and bottom rail, and the third and fourth modules are respectively the hinge and lock stiles of the door. In another embodiment, the third and fourth modules are identical. In yet another embodiment, the third and fourth modules are different in size, shape and/or material from each other.

In a further embodiment, the third and fourth modules each comprise at each end a tongue and a groove, the tongue pointing perpendicularly from the modules, preferably the tongue being complementary to the groove of the first and second modules, and wherein the groove of the third and fourth modules is complementary to the second tongue of the first and second modules.

In a further embodiment, the modules further comprise means for removably fixing the first module to the second module through the third and fourth modules. In one embodiment, the fixing means include apertures going through the first tongue of each end of the first module, apertures going through the third and fourth modules along their longitudinal axis, apertures going through, completely or not, the first tongue of the second module, and rods, screws, bolts or another releasable locking mechanism for assembly through said apertures, preferably the first and second modules comprise two of these apertures at each end and the third and fourth modules each comprise two apertures, where the apertures of the third and fourth modules respectively, are aligned with the apertures of the first and second modules when assembled.

In another embodiment, the fixing means include apertures going through the first tongue of each end of the first and second modules, apertures at each end of each of the third and fourth modules along their longitudinal axis, and rods, screws or bolts, for assembly through said apertures at each end of the third and fourth modules, preferably the first and second modules comprise two of these apertures on first tongue, and the third and fourth modules each comprise two apertures and each end, where the apertures of the third and fourth modules respectively, are aligned with the apertures of the first and second modules for assembly.

In one example, the door assembly system further comprises decorative covers for hiding the apertures (e.g., for inserting in the apertures) when these apertures go completely through the first tongue to the exterior edge of the second module.

The door assembly system as described above may be sold separately from the panels to be inserted in, or the assembly system may comprise one or more panels. In one embodiment, the assembly system comprises one panel. In another embodiment, the assembly system comprises two or more panels.

The door assembly system of the invention may also comprise, in the first and second modules, means for removably fixing one or more separator panels (e.g. cross or lock rails) between the first and second modules. In another embodiment, the door assembly system further comprises at least one separator panel for slidably mounting between the modules, and between two panels. In one embodiment, these separator panel fixing means comprise apertures going through the first module and the second module along an axis perpendicular to a longitudinal axis, and rods for assembly of a separator through said apertures. In another embodiment, the assembly system may comprise separators for vertical or horizontal insertion between panels and/or within the longitudinal grooves of the modules.

In one embodiment, the modules of the door assembly system comprise a material selected from wood, fiberboard, metal, polymer, wood-plastic composite (WPC), and combinations thereof. The panel or panels may be made of, for example, wood, glass, frosted glass, stained glass, polymer, or a combination thereof. In one embodiment, the panels further comprise muntins, cross rails and/or mullions, for example, the panel or panels comprise muntins (e.g. wood made) in combination with one or more material selected from glass, frosted glass, or stained glass, for example, to form a French door-type pattern. In one embodiment, the panel separators, cross rails, muntins, and/or mullions are made of the same material as the modules.

One aspect of the invention provides a door selected from an interior door or exterior door (e.g. a swinging (hinged), folding or pocket (sliding) door), a cabinet door or front panel of a drawer, a box or chest cover, and an interior or exterior window shutter.

Another aspect of the invention further provides a door assembly system as described in any of the foregoing embodiments, further comprising a side window or door header assembly system, or a combination thereof, each comprising a plurality of modules adapted for assembly to form a frame, each module comprising a first and second end, each of which comprising one or more complementary tongues and grooves for removably connecting each module to form the frame; and an interior and exterior edge, said interior edge having a groove along its longitudinal axis for slidably introducing one or more panels between said modules when assembled.

In another aspect, the invention provides a frame assembly system for embedding, for example, a mirror, glass (clear, frosted, or stained), picture, painting, image, photograph, or combination thereof, comprising a plurality of modules adapted for assembly to form a frame, each module comprising a first and second end, each of which comprising one or more complementary tongues and grooves for removably connecting each module to form the frame; and an interior and exterior edge, the interior edge having a groove along its longitudinal axis for slidably introducing the mirror, glass (clear, frosted, or stained), picture, painting, image, photograph, or combination thereof, between the modules when assembled.

According to one aspect, the invention also provides kits comprising a door assembly system of the invention together with fixing means, along with instructions for assembling the door assembly system, the one or more exchangeable panels being sold separately.

The invention also provides for kits comprising a door assembly system of the invention together with fixing means and one panel or a plurality of interchangeable panels, along with instructions for assembling the door assembly system.

According to another aspect, the invention also provides kits comprising a frame assembly system of the invention together with fixing means, along with instructions for assembling the fame assembly system, the interchangeable mirror, picture, painting, etc, being sold separately.

### BRIEF DESCRIPTION OF THE DRAWINGS

The description of the invention will be made having reference to the following Figures, which constitute examples of door assembly systems according to embodiments of the invention, and should not be construed as further limiting.

FIG. 1(a) shows a front elevation view of an assembled door assembly system, 1(b) shows a top view, 1(c) shows a hinge side elevation view, and 1(d) shows a lock side elevation view;

FIG. 2(a) shows a perspective view of a hinge stile module, 2(b) shows a perspective view of a lock stile module, 2(c) shows a perspective view of a top rail module, 2(d) shows a perspective view of a bottom rail module, and 2(d) shows a perspective view of a lock or cross rail module or separator;

FIGS. 3(a) to (j) show front views of assembled door assembly systems: 3(a) shows a door assembly system with one panel only, 3(b) to 3(j) show door assemblies with multiple panels, one or more cross or lock rail(s), one or more mullion(s), and/or one or more muntin(s);

FIG. 4 shows an example of an assembled door assembly system and matching side windows, including stained glass panels; and

FIG. 5 shows an example of kitchen cabinets and drawers made using the door assembly systems.

### DETAILED DESCRIPTION OF EXEMPLARY EMBODIMENTS

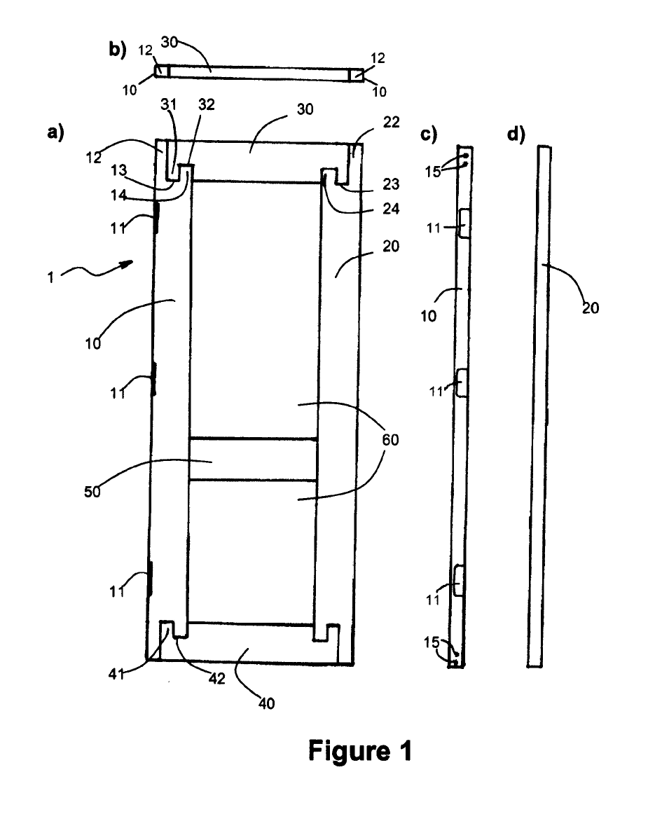

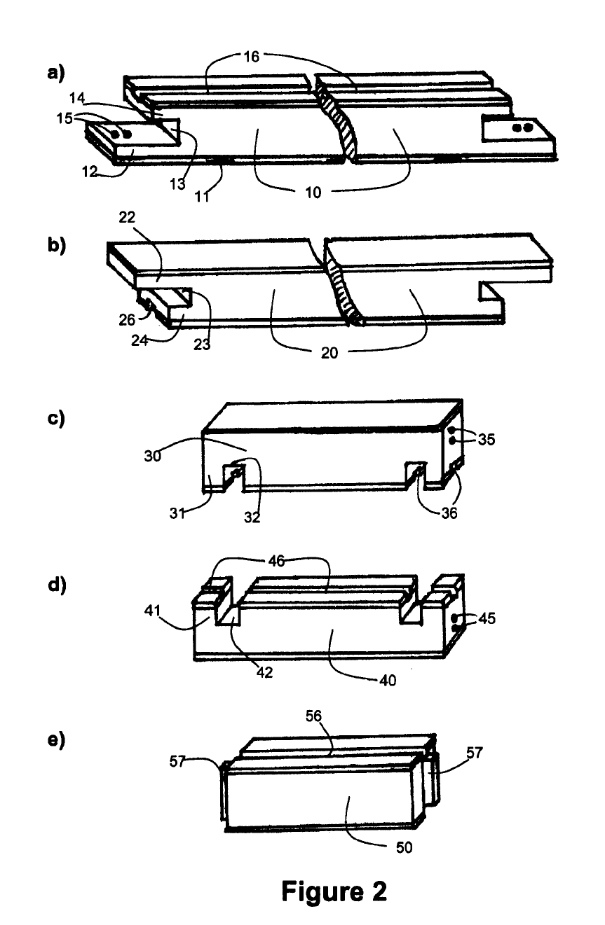

Referring to the Figures, and especially FIGS. 1 and 2, there is provided a door assembly system 1, comprising a hinge stile module 10, a lock stile module 20, a top rail module 30, a bottom rail module 40, a cross or lock rail (or separator) 50, and two panels 60.

The lock and hinge stile modules 10 and 20 may be substantially identical (as in FIGS. 1 and 2(a) and (b)), or may be different. The top and bottom rail modules 30 and 40 may be identical as in FIGS. 1 and 2(c) and (d). Alternatively, the top and bottom rail modules 30 and 40 can be of different size, shape and/or material from each other. As an example, when the top and bottom rail modules 30 and 40 would be laying down side by side on their exterior edge (the longest edge of each module) for comparison, the bottom rail module 40 would raise higher than the top rail module 30.

The modules are installed together in a tongue and groove fashion. Stile modules 10 and 20 respectively include tongues 12 and 22, tongues 14 and 24 and grooves 13 and 23 for receiving tongues 31 and 41, respectively from rails 30 and 40. grooves 32 and 42 respectively from rails 30 and 40 are also adapted to receive tongues 14 and 24 from stile modules 10 and 20.

The door assembly system also includes means for removably assembling the system modules. For that purpose, apertures 15, 35 and 45 are respectively found in the hinge stile module 10, the top rail module 30 and the bottom rail module 40. The lock stile module 20 does also include apertures not shown in the Figures. These are similar to the ones found in the hinge stile module with the exception that they do not completely go through tongues 22, such that they are not visible on the outside egdge once the system is assembled. Alternatively, the apertures could completely go through tongues 22, and the assembly system be provided with removable caps which would hide the apertures in a more aesthetic fashion.

The door system is assembled by first permanently or non-permanently fixing bottom rail module 40 to hinge and lock stiles 10 and 20, by fitting a rod, screw or bolt through apertures 15 of module 10, through apertures 45 of the bottom rail module 40, and into the apertures (not shown) of the lock stile module 20. The second step would be to insert a first panel 60 by sliding the panel into the longitudinal grooves 16 and 26 of the hinge stile and lock stile modules 10 and 20 until the panel 60 sits in the longitudinal groove 46 of bottom rail module 40. The cross rail 50 is then inserted by sliding tongues 57 in grooves 16 and 26 until the bottom groove 56 sits on the first panel 60. A second panel 60 is inserted in the same manner until it sits into the top groove 56 of cross rail 50. Finally, the top rail module is then inserted until tongues 31 are fitted into grooves 13 and 23, tongues 14 and 24 fitted into grooves 32, and non-permanently secured by inserting rods (screws, or bolts) into apertures 15, 35 and the ones (not shown) in the lock stile module 20. The hinge stile module 10 also comprises hinge mortises 11 to install the door into the door frame.

Alternatively, the cross rail 50 may comprise apertures such as for the top and bottom rails and be secured to the hinge and lock stiles with rods, bolts or screws, through apertures in the hinge and stiles.

Preferably, at least one of the bottom and top rails is removable, preferably the top rail, such that the desired versatility is obtained. For example, one may remove the top rail module and change the panels and/or cross rails with different panels made from different materials or having different appearances, such as going from a wooden panel to a stained glass panel.

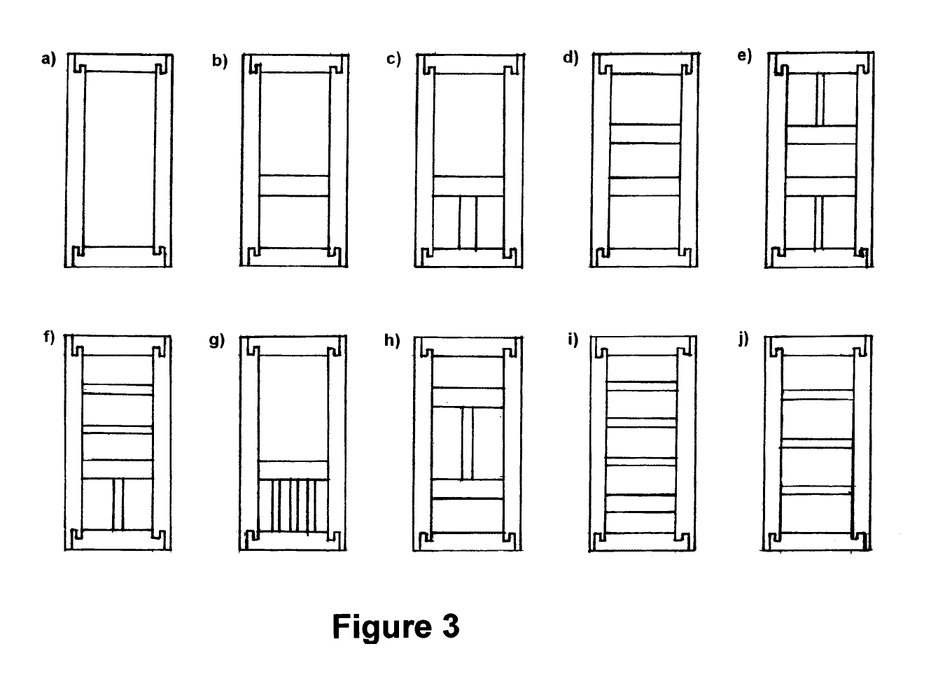

Another example of a door assembly system further comprises one or more mullion(s), such as shown in FIG. 3(c), in which the mullion is a piece similar to the cross rail of FIG. 2(e), i.e. comprising tongues 57 and grooves 56 as for cross rail 50. In this case, a mullion is to be inserted between two panels, where the panel would fit into grooves 56 of the mullion, and one tongue 57 inserted into the groove 46 of the bottom rail module, a cross rail 50 is then inserted as previously described until its bottom groove 46 fits onto the two panels and the mullion's groove 57. Alternatively, mullions, muntins and cross rails are already part of the panel or panels to be inserted.

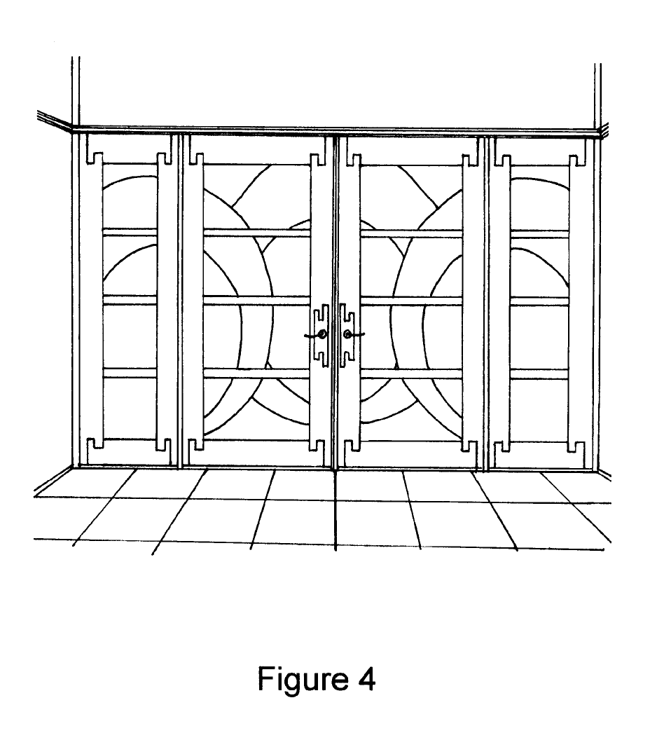

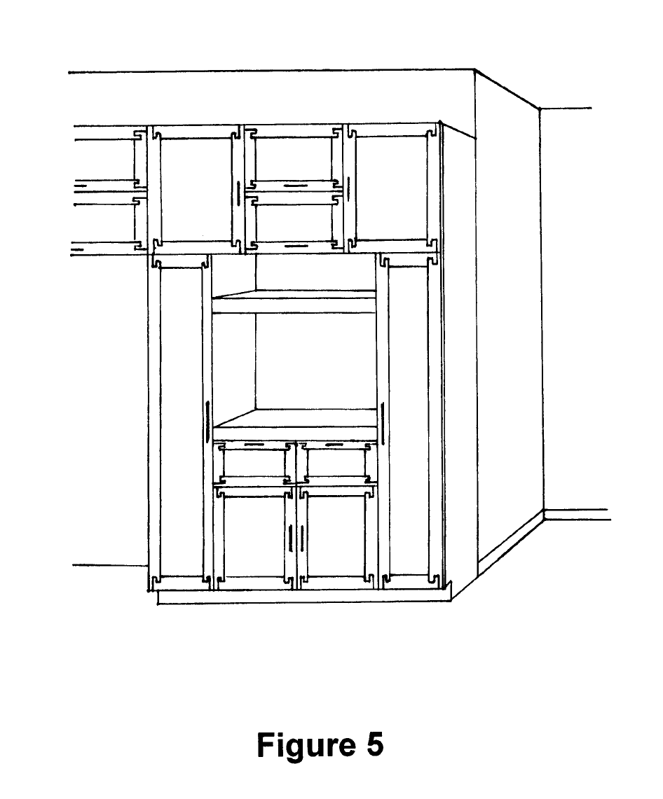

The door may be an interior or exterior door, a swinging (hinged), folding or pocket (sliding) door. It may also be a cabinet door, such as a kitchen cabinet door or the front panel of a drawer (for example, see FIG. 5), a box or chest cover, an interior or exterior window shutter, or any other type of door. The same principle can also be applied to door headers or side windows matching the doors (see FIG. 4), preferably non permanently fixed windows.

The rail and stile modules, as well as the cross rails, muntins and mullions, may be made of any sturdy building material known to the skilled artisan such as, without limitation, wood (e.g. pine, mahogany, oak, alder, walnut, cherry, maple, and the like), metal (e.g. steel or aluminum), polymers (e.g. thermoplastic or thermosetting polymers), medium-density fiberboard (MDF), wood-plastic composite (WPC), or any combination of these.

The panels can be made out of any acceptable building materials, including, but not limited to wood, glass (e.g. clear, stained, or frosted glass, and combinations thereof), amorphous or semi-crystalline solid polymers (e.g. thermoplastics (e.g. polyethylene, polyvinyl chloride, poly(methyl methacrylate) (Plexiglas™), polytetrafluoroethylene (PTFE), and the like) and thermosetting polymers (e.g. melamine)), medium-density fiberboard (MDF), or composite material (e.g. wood-plastic composite (commonly abbreviated as WPC)). The panels may also include blinds or be in the form of a louver in a frame which is adapted for insertion into the longitudinal grooves of the modules. The panels may be flat or raised panels and/or include mouldings, muntins and/or mullions.

Another aspect of the invention provides a frame assembly system, such as for a mirror, picture, painting, image, or photograph, having the same characteristics as described for the door assembly system.

The invention also provides for kits comprising a door assembly system of the invention together with fixing means and one panel or a plurality of exchangeable panels, along with instructions for assembling the door assembly system.

1. A door assembly system comprising:
a plurality of modules adapted for assembly to form a frame of a frame-and-panel-type door, each module comprising:
a first and second end, each of which comprising one or more complementary tongues and grooves for removably connecting each module to form said frame; and
an interior and exterior edge, said interior edge having a longitudinal groove along its longitudinal axis for slidably introducing one or more panels between said modules when assembled.

2. The door assembly system of claim 1, wherein said plurality of modules comprises a first and a second modules, the first module comprising two stiles and a first rail, and the second module comprising a second rail, or a first module comprising two rails and a first stile, and the second module comprising a second stile.

3. The door assembly system of claim 1, wherein said plurality of modules comprises a first, second, third and fourth modules, and wherein said first and second modules are each adapted for perpendicular assembly to said third and fourth modules, with said first and second modules being parallel and facing each other, and said third and fourth modules being parallel and facing each other.

4. The door assembly of claim 3, wherein said first and second modules each comprise at each end a first and second tongues, and a groove, said first and second tongues separated by said groove and pointing away from said modules along a longitudinal axis.

5. The door assembly system of claim 3, wherein said first tongue is the continuity of the exterior edge of said module, and wherein said second tongue is the continuity of the interior edge of said module.

6. The door assembly system of claim 5, wherein said first and second tongue, taken together with said first groove form an asymmetrical square U-shape.

7. The door assembly system of claim 3, wherein said third and fourth modules each comprise at each end a tongue and a groove, said tongue pointing perpendicularly from said modules.

8. The door assembly system of claim 4, wherein said top and bottom modules each comprise at each end a tongue and a groove, said tongue pointing perpendicularly from said modules and being complementary to the groove of said first and second modules, and wherein said groove of the third and fourth modules is complementary to the second tongue of the first and second modules.

9. The door assembly system of claim 3, wherein said door assembly system further comprises means for removably fixing the first module to the third and fourth modules, and said third and fourth modules to the second module.

10. The door assembly system of claim 9, wherein said fixing means comprise apertures going through the first tongue of each end of the first module, apertures into the third and fourth modules following a longitudinal axis, apertures into the first tongue of the second module, and rods, screws or bolts for assembly through said apertures.

11. The door assembly system of claim 10, wherein said apertures of said third and fourth modules go through said modules along a longitudinal axis.

12. The door assembly system of claim 10, wherein said apertures of said third and fourth modules are located at each end of the modules, along a longitudinal axis.

13. The door assembly system of claim 10, further comprising decorative covers for covering said apertures when said apertures go completely through the first tongue of the second module.

14. The door assembly system of claim 1, further comprising one panel.

15. The door assembly system of claim 1, wherein said door assembly system further comprise means for removably fixing one or more panel separators between the first and second modules, and wherein said fixing means comprise apertures going through the first module and the second module along an axis perpendicular to a longitudinal axis, and rods, screws, or bolts, for assembly of the separator through said apertures.

16. The door assembly system of claim 1, further comprising a plurality of panels, and optionally further comprising at least one panel separator for slidably mounting between the modules, and between two of said plurality of panels.

17. The door assembly system of claim 3, wherein said first and second module consist respectively of a hinge stile and a lock stile, and said third and fourth modules consist respectively of a top rail and a bottom rail of said door.

18. The door assembly system of claim 3, wherein said first and second module consist respectively of top rail and bottom rail, and third and fourth modules consist respectively of hinge stile and lock stile of said door.

19. The door assembly system of claim 1, wherein said modules comprise a material selected from wood, metal, polymer, medium-density fiberboard (MDF), wood-plastic composite (WPC), and combinations thereof, wherein said panel or panels comprise wood, glass, frosted glass, stained glass, medium-density fiberboard (MDF), polymer, or a combination thereof, and wherein said panel or panels optionally comprise wood and one or more of glass, frosted glass, or stained glass arranged into a French door pattern.

20. The door assembly system of claim 1, wherein said door is selected from an interior door, an exterior door, a cabinet door or front panel of a drawer, a cover of a box or chest, and an interior or exterior window shutter.
